(19) United States
(12) Patent Application Publication
(10) Pub. No.: US 2021/0059468 A1
(43) Pub. Date: Mar. 4, 2021

(54) CHAFFING DISH ASSEMBLY HAVING SUPPORT PAN AND STOPPER RAIL

(71) Applicant: Sterno Products, LLC., Corona, CA (US)

(72) Inventors: David Amirault, Corona, CA (US); Steven Lee Cox, Corona, CA (US); Paul Thomas Zink, Corona, CA (US); Andrew Brent Mendenhall, Corona, CA (US); Dennis Matthew Turner, Corona, CA (US)

(21) Appl. No.: 16/559,499

(22) Filed: Sep. 3, 2019

(51) Int. Cl. A47J 36/24

(52) U.S. Cl. CPC A47J 36/2405

(57) ABSTRACT

A chafing dish assembly for use with first and second food trays. The chafing dish assembly includes a support pan and a stopper rail. The support pan further includes a support pan lip with a lip top surface sized and configured to support the food trays. The support pan lip has stopper grooves disposed along the lip top surface. The stopper rail includes first and second positioning tabs extending at each end of the rail. The stopper rail is cooperatively sized and configured with the first and second positioning tabs respectively received in the stopper grooves with the rail spanning across an open top of the support pan and with the first and second food trays positioned in the support pan and supported by the stopper rail.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to chafing dishes. More particularly, the present disclosure relates to a chafing dish assembly that includes a support pan and a stopper rail.

### 2. Related Art

A chafing dish has an outer pan that is configured to hold water and to support one or more food trays inside the outer pan. A metal support frame holds the outer pan and one or more food trays (also referred to as food pans). The support frame also supports at least one methanol-based or ethanol-based burner. The food trays, reusable, heavy gauge metal pans or thin walled disposable trays made of aluminum, are held by the support frames above the water level in the chafing dish. In other arrangements, the outer pan may have a rim which supports an outer flange of the food tray. The burners heat the outer pan sufficiently to boil water inside the outer pan and to generate steam for cooking food in the food tray(s) or to maintain pre-cooked food in the food tray(s) at a suitable temperature. Depending on the heating time and desired temperature, more than one methanol burner may be used simultaneously or sequentially.

Other chafing dish arrangements may not use an external heat source, but rather use a packet containing an exothermic compound that is reactive with water that is placed in the water of the outer pan. The exothermic compound has an exothermic reaction with the water sufficient to cause the water to form steam to heat the food tray(s) and contents therein.

Chafing dishes may come in a variety of sizes, and may be configured to accommodate common commercial catering sized food trays. A common food tray is a rectangular and is 20¾ inches long by 12¾ inches wide. This food tray dimensioning is commonly referred to as a “full size” pan. There are several common depths that correspond to such “full size” pan, that range from 2½ inches to six inches deep. Other common sizes for such foods trays are fractions of a “full size” pan, such as “half” pan, “one third” pan, “two thirds” pan, “one fourth” pan, as so forth. In this regard, two “half” pans would fit in a chafing dish sized to fit one “full size” pan. In this case, the two half pan sized food trays abut each other with three sides of each food tray being supported by the chafing dish. With such common fractional sizes, it is contemplated that a given chafing dish may be readily used with a variety of food trays.

Where more than one food tray is used there is an issue with having a poor seal between the food trays and the supporting outer pan. Such a poor seal results in an undue loss of steam which impacts both the temperature at which the chafing dish is able to maintain the food tray and the duration of when a total loss of water occurs thereby ending the ability to generate steam. Further, escaping steam and sputtering of condensed steam may result in the potential for burn and scaling injuries. The poor seal is a result of the outer flanges of the food trays not having one or two sides in direct contact with a supporting portion of the outer pan or support frame. In the case of two “half pan” sized food trays, each food tray would have its outer flange supported adjacent at sides of the food pan with each food tray having one of its sides abutting each other across the outer pan. Steam leakage would be expected along at such abutting sides. In the case of three “third pan” sized food trays, the three food trays would be lined up together with a center food tray only being supported along two its sides with the other two sides abutting an adjacent food tray.

In view of the foregoing, there is a need in the art for an improved chafing dish arrangement.

### BRIEF SUMMARY

In accordance with one embodiment, there is provided a chafing dish assembly for use with first and second food trays. Each of the first and second food trays have a rectangular tray top, a tray bottom, a food tray sidewall extending between the tray top and tray bottom, and a food tray flange extending outward from the tray top. The chafing dish assembly includes a rectangular support pan. The support pan includes a pan sidewall having a bottom edge and an upper edge. The support pan further includes a closed bottom joining the bottom edge to form an enclosed container. The support pan further includes an open top surrounded by the upper edge and disposed opposite the closed bottom. The support pan further includes a support pan lip extending outwardly from the upper edge. The support pan lip has a lip top surface sized and configured to support the food tray flanges of the first and second food trays. The support pan lip has first and second stopper grooves disposed along the lip top surface.

It is contemplated that the stopper rail improves the seal of the first and second food trays over the open top of the support pan. This is because the food tray flange of each the first and second food trays is directly supported by the stopper rail between the first and second food trays. The stopper rail extends across the open top and serves to block the escape of steam from the enclosed container of the support pan. The abutting sides of the first and second food trays commonly share the support and direct contact with the stopper upper surface. The remainder of the food tray flange of each of the first and second food trays is supported by and in contact with the support pan lip. As such, the food tray flange is supported all the way around each of the first and second food trays. Such support and seal results in an undue loss of steam which impacts both the temperature at which the chafing dish assembly is able to maintain each of the first and second food trays and the duration of when a total loss of water occurs thereby ending the ability to generate steam.

The chafing dish assembly further includes a stopper rail. The stopper rail includes an elongate rail body having first and second ends. The stopper rail further includes a stopper upper surface extending along the rail body between the first and second ends. The stopper rail further includes first and second positioning tabs respectively extending from each of the first and second ends. The stopper rail is cooperatively sized and configured with the first and second positioning tabs respectively received in the first and second stopper grooves with the rail body spanning across the open top and with the first and second food trays positioned in the enclosed container and the food tray flange of the first food tray being supporting by the stopper upper surface and the lip top surface and the food tray flange of the second food tray being supporting by the stopper upper surface and the lip top surface.

According to various embodiments, the first and second ends of the rail body each may extend in a direction away from the stopper upper surface. The first and second ends of the rail body may be curved and the first and second positioning tabs respectively extend distally from the first and second ends. The rail body may have a lateral width less than a lateral width of the first and second positioning tabs. The rail body may have a lateral width that increasingly tapers at the first and second ends. The food tray sidewall of each of the first and second food trays may have four rounded corner sections adjacent the food tray flange. Each of the first and second ends may have a concave filet cooperatively sized and configured to receive a rounded corner section of a respective one of the first and second food trays. The stopper rail may be cooperatively sized and configured to have the stopper upper surface and the lip top surface vertically aligned with the first and second positioning tabs being respectively received in the first and second stopper grooves with the rail body spanning across the open top and with the first and second food trays positioned in the enclosed container. Each of the first and second stopper grooves may have a rounded cross section.

Further, each of the first and second grooves may have opposing first and second stopper groove ends, and the first and second stopper grooves may each have a depth that tapers from the lip top surface at the first stopper groove end towards to the second stopper groove end and tapers from the lip top surface at the second stopper groove end toward the first stopper groove end. The pan sidewall may have opposing longitudinal sides and opposing lateral sides disposed between the longitudinal sides, and the first and second stopper grooves may be respectively disposed along the longitudinal sides. Each longitudinal side may have a groove ledge disposed along the upper edge, and the first and second stopper grooves may each be disposed between a respective one of the groove ledges and the lip top surface. Each ledge of each longitudinal side may be disposed at a distance from the closed bottom less than a distance from the lip top surface to the closed bottom. The support pan may include a peripheral bead extending around a periphery of the support pan lip and a depending flange extending downward and outward from the bead. The pan sidewall may have upper and lower sidewalls and a tray ledge disposed between the upper and lower sidewalls.

In addition, the chafing dish assembly may further include a suspension tray. The suspension tray may have a rectangular tray top with an outer periphery that fits inside the support pan and rests on the tray ledge, and the suspension tray may have a pocket depending from the tray top toward the closed bottom of the support pan. The suspension tray may have a pocket bottom spaced apart from the closed bottom. The support pan may include guide tabs extending from the tray ledge towards the open top, and the suspension tray may be disposed between respective ones of the guide tabs. The support pan and stopper rail may be made of metal. The stopper rail may be a first stopper rail, and the chafing dish assembly may further include a second stopper rail sized and configured the same as the first stopper rail. The first and second stopper rails may be positionable with the respective first and second positioning tabs being respectively received in the first and second stopper grooves with the rail bodies spanning across the open top.

The present invention will be best understood by reference to the following detailed description when read in conjunction with the accompanying drawings.

### BRIEF DESCRIPTION OF THE DRAWINGS

These and other advantages and features of the invention will be better appreciated in view of the following drawings and descriptions in which like numbers refer to like parts throughout, and in which:

FIG. 1 is a top perspective view of a support pan according to an aspect of the invention;

FIG. 2 is a top plan view of the support pan;

FIG. 3 is an end view of the support pan;

FIG. 4 is a cross sectional view of the support pan as viewed along axes 4-4 of FIG. 2;

FIG. 5 is an side view of the support pan;

FIG. 6 is a cross sectional view of the support pan as viewed along axes 6-6 of FIG. 2;

FIG. 7 is a bottom plan view of the support pan;

FIG. 8 is an enlarged cross sectional view of a portion of the support pan at a stopper groove as viewed along axes 8-8 of FIG. 2;

FIG. 9 is an enlarged cross sectional view of a portion of the support pan at the stopper groove as viewed along axes 9-9 of FIG. 2;

FIG. 10 is an exploded perspective view of a chafing dish assembly, including the support pan, a stopper rail and a suspension tray, with two food trays;

FIG. 11 is an assembled perspective view of the chafing dish assembly of FIG. 10;

FIG. 12 is an assembled perspective view of the chafing dish assembly and food trays of FIG. 10;

FIG. 13 is a top perspective view of the stopper rail;

FIG. 14 is a bottom perspective view of the stopper rail;

FIG. 15 is a side cross-sectional view of a first end of the stopper rail as viewed along axes 15-15 of FIG. 13;

FIG. 16 is a bottom plan view of the stopper rail;

FIG. 17 is a cross sectional side view of the stopper rail as viewed along axes 17-17 of FIG. 13;

FIG. 18 is an end view of the stopper rail;

FIG. 19 is a top perspective view of the suspension tray;

FIG. 20 is a side plan view of the suspension tray;

FIG. 21 is an end view of the suspension tray;

FIG. 22 is a cross sectional side view of the chafing dish assembly as viewed along axes 22-22 of FIG. 11;

FIG. 23 is a cross sectional end view of the chafing dish assembly as viewed along axes 23-23 of FIG. 11;

FIG. 24 is a perspective view of four chafing dish assemblies, including a set of four and stacked support pans and suspension trays and six stopper rails;

FIG. 25 is a side view of the chafing dish assemblies of FIG. 24;

FIG. 26 is an end view of the chafing dish assemblies of FIG. 24;

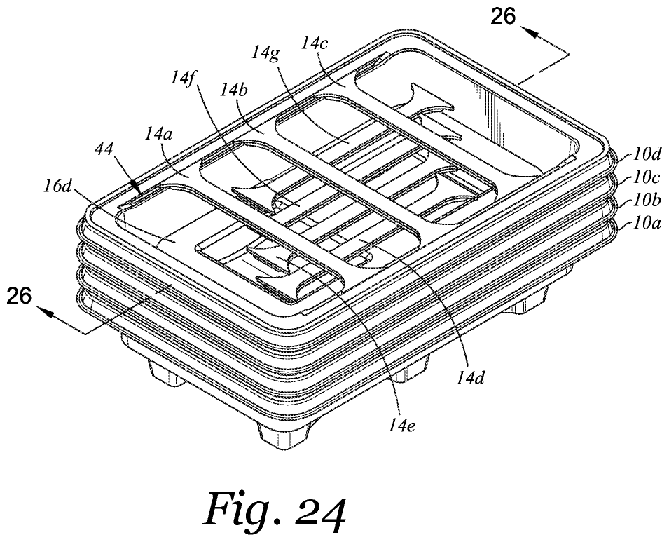

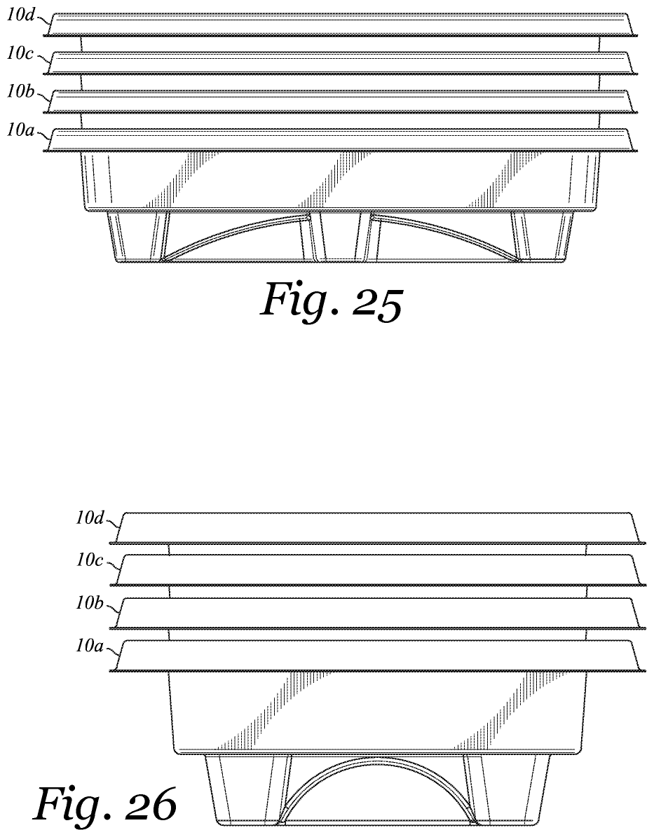

FIG. 25 is a cross-sectional side view of the chafing dish assemblies of FIG. 24 as viewed along axes 27-27;

FIG. 28 is an exploded perspective view of the chafing dish assemblies of FIG. 24;

FIG. 29 is an end view of the chafing dish assemblies of FIG. 28; and

FIG. 30 is a side view of the chafing dish assemblies of FIG. 28.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as top and bottom, first and second, and the like are used solely to distinguish one entity from another without necessarily requiring or implying any actual such relationship or order between such entities.

As used herein, the relative directions up and down or above and below refer to relative directions along the vertical axis. The relative directions inward and outward refer to lateral directions in the horizontal plane, orthogonal to the vertical axis toward and away from an axis through the center of the chafing dish. As used herein a chafing dish assembly may include a chafing dish in the form of a support pan for one or more food trays. with or without the food trays.

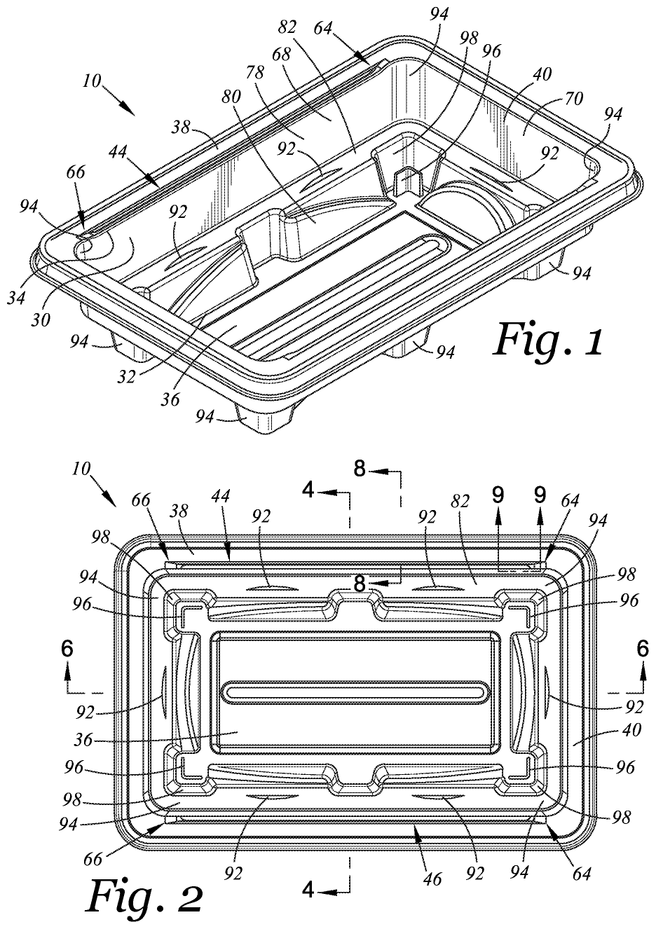

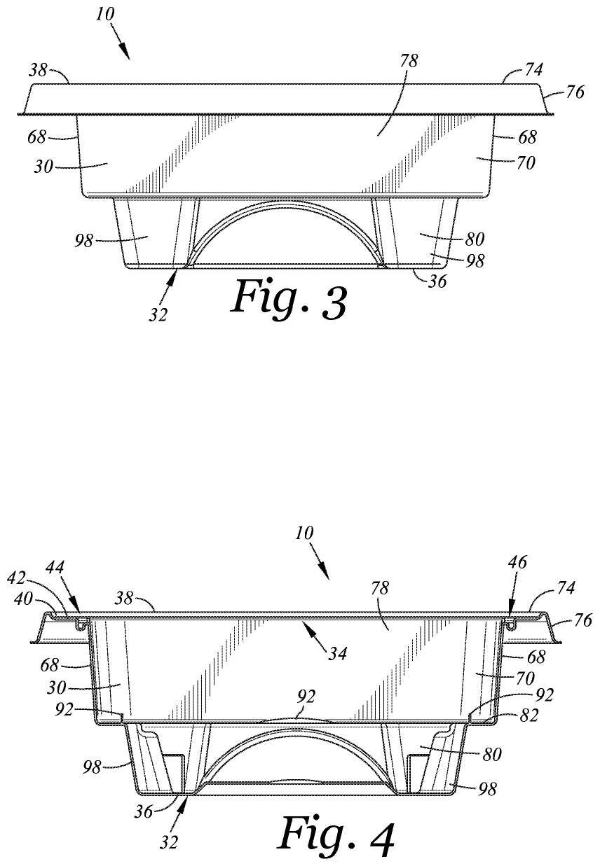

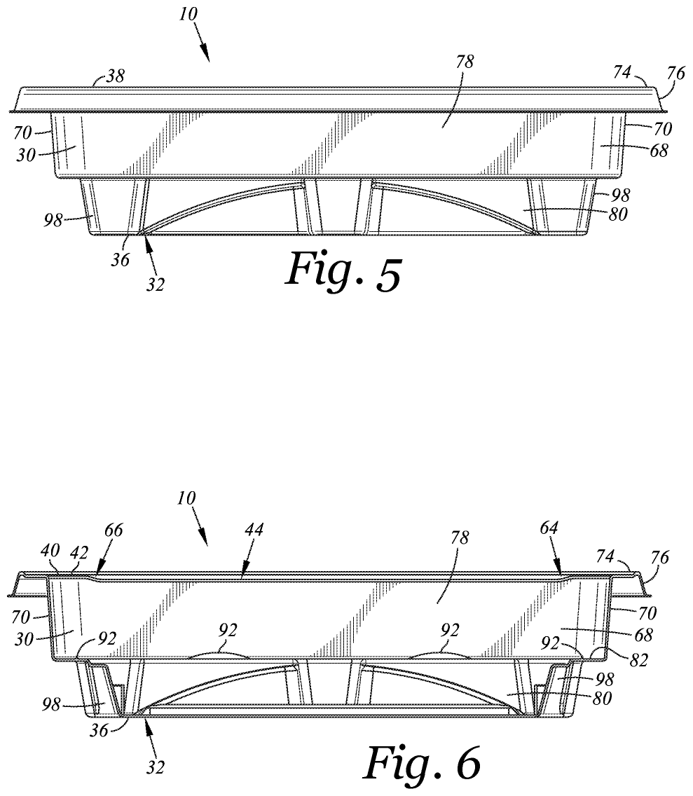

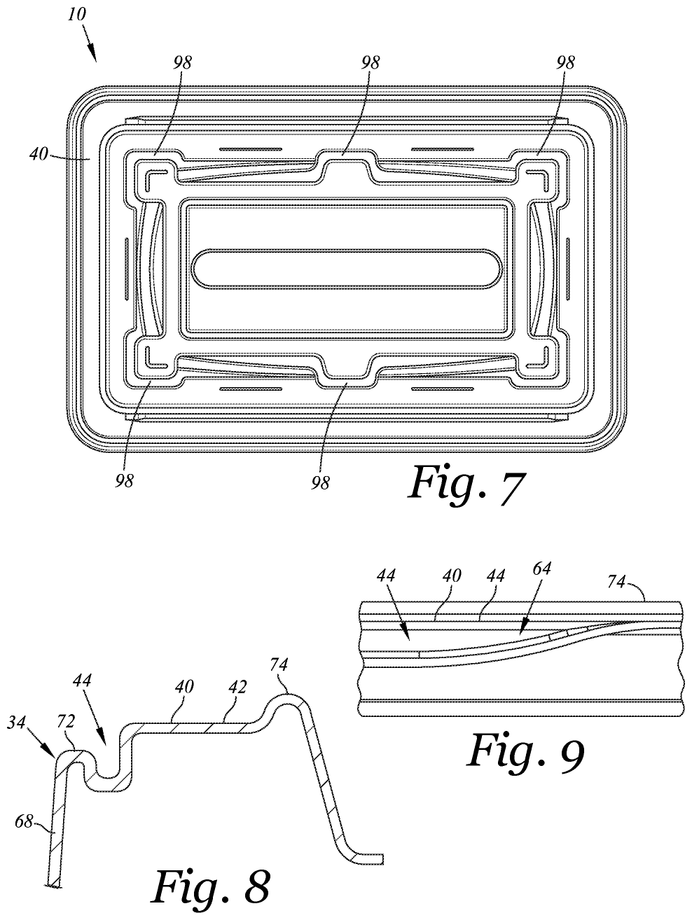

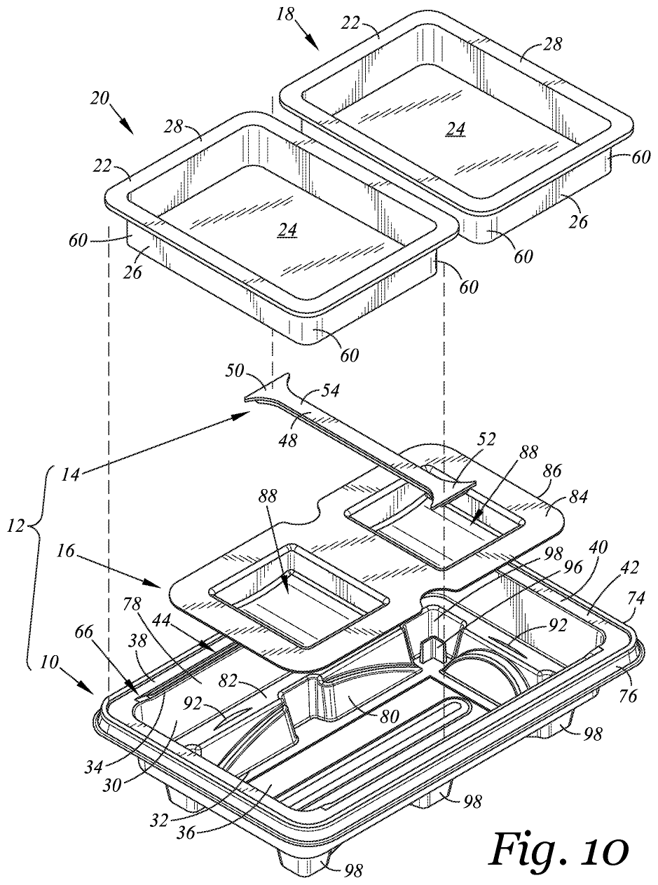

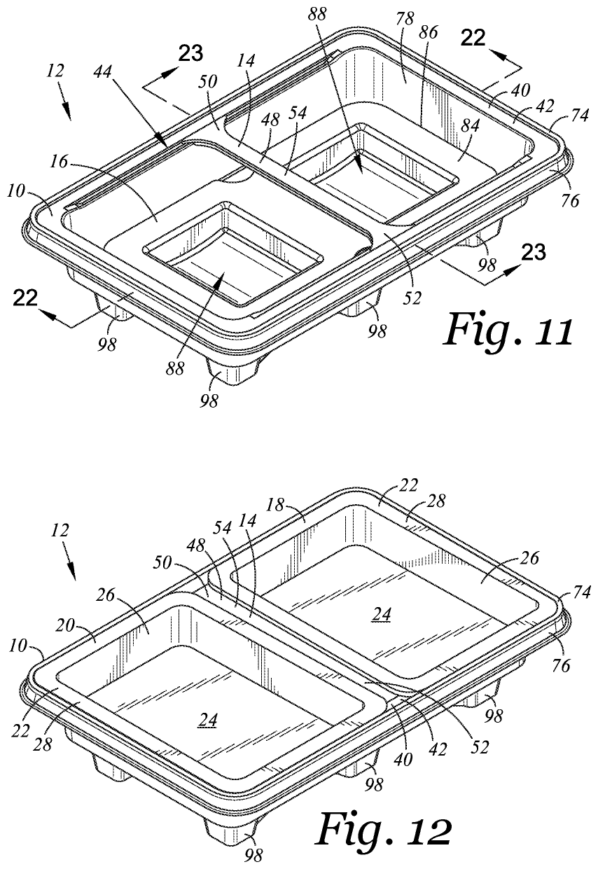

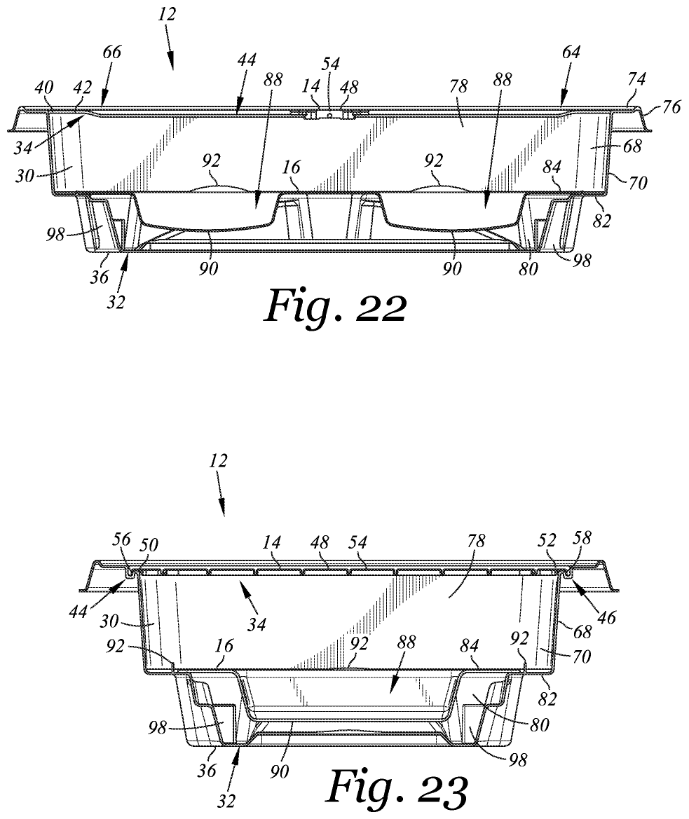

Referring to FIGS. 1-7, there is provided a support pan 10 in accordance with an aspect of the present invention. FIG. 10 is an exploded perspective view of a chafing dish assembly 12, including the support pan 10, a stopper rail 14 and a suspension tray 16, with first and second food trays 18, 20. FIG. 11 is an assembled perspective view of the chafing dish assembly of FIG. 10, and FIG. 12 is an assembled perspective view of the chafing dish assembly 12 and the first and second food trays 18, 20 of FIG. 10. FIG. 22 is a cross sectional side view of the chafing dish assembly 12 as viewed along axes 22-22 of FIG. 11; and FIG. 23 is a cross sectional end view of the chafing dish assembly 12 as viewed along axes 23-23 of FIG. 11.

In accordance with one embodiment, there is provided the chafing dish assembly 12 for use with the first and second food trays 18, 20. Each of the first and second food trays 18, 20 have a rectangular tray top 22, a tray bottom 24, a food tray sidewall 26 extending between the tray top 22 and tray bottom 24, and a food tray flange 28 extending outward from the tray top 22. The chafing dish assembly 12 includes the rectangular support pan 10. The support pan 10 includes a pan sidewall 30 having a bottom edge 32 and an upper edge 34. The support pan 10 further includes a closed bottom 36 joining the bottom edge 32 to form an enclosed container. The support pan 10 further includes an open top 38 surrounded by the upper edge 34 and disposed opposite the closed bottom 36. The support pan further includes a support pan lip 40 extending outwardly from the upper edge 34. The support pan lip 40 has a lip top surface 42 sized and configured to support the food tray flanges 28 of the first and second food trays 18, 20. The support pan lip 40 has first and second stopper grooves 44, 46 disposed along the lip top surface 42.

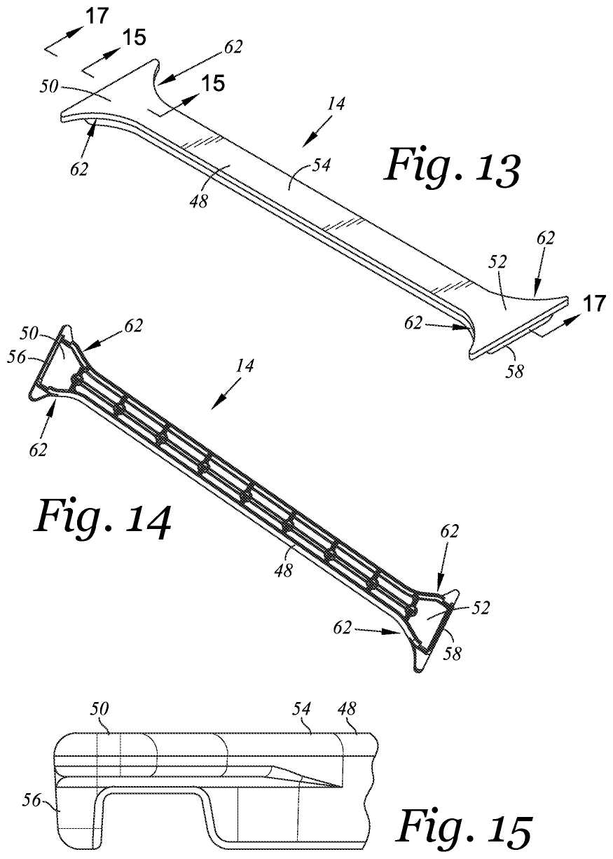

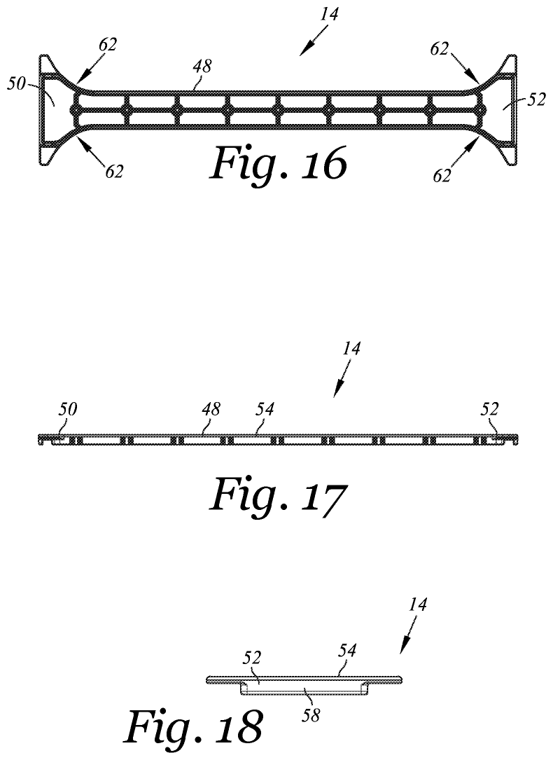

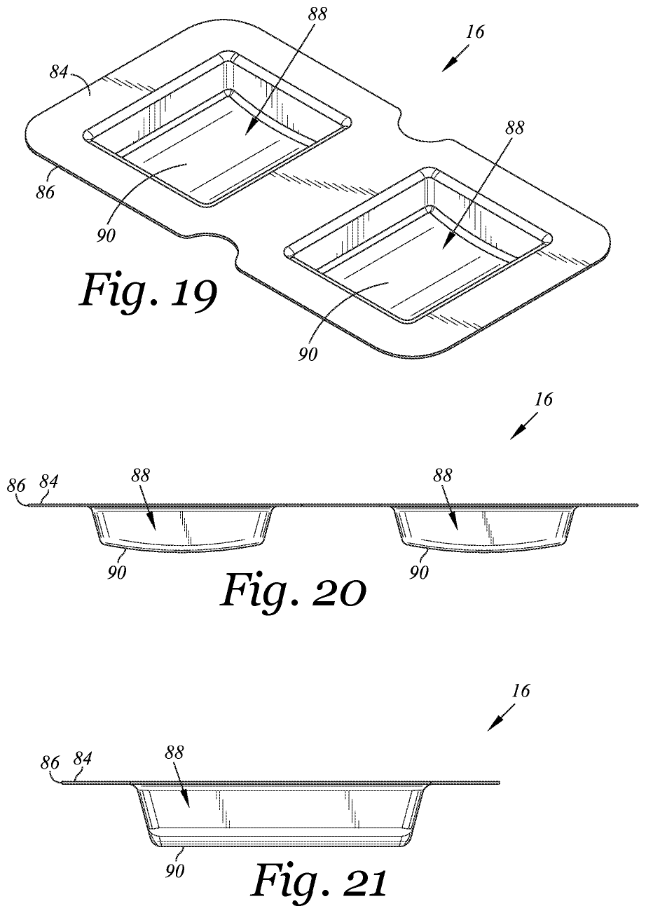

As mentioned above, the chafing dish assembly 12 further includes the stopper rail 14. FIGS. 13-14 and 16-18 depict various views of the stopper rail 14. The stopper rail 14 includes an elongate rail body 50 having first and second ends 52, 54. The stopper rail 14 further includes a stopper upper surface 54 extending along the rail body 48 between the first and second ends 48, 50. The stopper rail 14 further includes first and second positioning tabs 56, 58 respectively extending from each of the first and second ends 50, 52. The stopper rail 14 is cooperatively sized and configured with the first and second positioning tabs 56, 58 respectively received in the first and second stopper grooves 44, 46 with the rail body 48 spanning across the open top 38 and with the first and second food trays 18, 20 positioned in the enclosed container and the food tray flange 28 of the first food tray 18 being supporting by the stopper upper surface 54 and the lip top surface 42 and the food tray flange 18 of the second food tray 20 being supporting by the stopper upper surface 54 and the lip top surface 42.

It is contemplated that the stopper rail 14 improves the seal of the first and second food trays 18, 20 over the open top 38 of the support pan 10. This is because the food tray flange 28 of each the first and second food trays 18, 20 is directly supported by the stopper rail 14 between the first and second food trays 18, 20. The stopper rail 14 extends across the open top 38 and serves to block the escape of steam from the enclosed container of the support pan 10. The abutting sides of the first and second food trays 18, 20 commonly share the support and direct contact with the stopper upper surface 54. The remainder of the food tray flange 28 of each of the first and second food trays 18, 20 is supported by and in contact with the support pan lip 40. As such, the food tray flange 28 is supported all the way around each of the first and second food trays 18, 20. Such support and seal results in an undue loss of steam which impacts both the temperature at which the chafing dish assembly 12 is able to maintain each of the first and second food trays 18, 20 and the duration of when a total loss of water occurs thereby ending the ability to generate steam.

According to various embodiments, referring additionally to FIG. 15, there is depicted a side cross-sectional view of the first end 50 of the stopper rail 14 as viewed along axes 15-15 of FIG. 13. The first and second ends 50, 52 of the rail body 48 each may extend in a direction away from the stopper upper surface 54. In an embodiment, the first and second ends 50, 52 of the rail body 48 may be curved. The first and second positioning tabs 56, 58 respectively extend distally from the first and second ends 50, 52. In the view of FIG. 15, the first end 50 is curved downward with the first positioning tab 56 pointed directly down and has a claw-like shape. This shaping allows stopper rail 14, and in particular the first and second positioning tabs 56, 58, to readily grip and engage the first and second stopper grooves 44, 46. Each of the first and second stopper grooves 44, 46 may have a rounded cross section to readily receive the first and second positioning tabs 5,6 58.

The first and second food trays 18, 20 may be of various sizes, and may be of such sizing as those which are commonly commercially available. It is contemplated that the support pan 10 is sized relative to the sizing of the food tray sidewall 26 and food tray flange 28 of the first and second food trays 18, 20. In particular, the support pan lip 40 and pan sidewall 30 are sized to as to allow the food tray sidewall 26 of both the first and second food trays 18, 20 to fit in the support pan 10 without the food tray flange 28 of the first food tray 18 overlapping with the food tray flange 38 of the second food tray 20. This would allow sufficient spacing for the first and second food trays 18, 20. However, such spacing is intentionally designed have a minimal gap between the abutting first and second food trays 18, 20 while still allowing a slight leeway for lateral movements of the first and second food trays 18, 20. This would allow for an ease of placement and removal of the first and second food trays 18, 20 and would allow for accommodation in situations where the support pan 10 and/or the first or second food trays 18, 20 have become warped in shape.

The lateral width of the rail body 48 must be larger than any gap that may be formed between the abutting first and second food trays 18, 20 once the first and second food trays 18, 20 are placed in the support pan 10 with the food tray flange 28 of each of the first and second food trays 18, 20 are supported by the lip top surface 42. In this regard, the rail body 48 and the stopper upper surface 54 may have a lateral width sufficient to allow the food tray flange 28 of each of the first and second food trays 18, 20 to be simultaneously supported. It is contemplated that the greater the simultaneous overlap between the stopper upper surface 54 and the food tray flange 28 of each of the first and second food trays 18, 20 would generally result in a better seal to mitigate the escape of steam from the support pan 10. Further, the rail body 48 and the stopper upper surface 54 are contemplated to have a lateral width less than a gap between the abutting food tray sidewall 26 of each of the first and second food trays 18, 20 with the first and second food trays positioned in the support pan 10.

The rail body 48 may have a lateral width less than a lateral width of the first and second positioning tabs 56, 58. The rail body 48 may have a lateral width that increasingly tapers at the first and second ends 50, 52. With reference to FIG. 10, the food tray sidewall 26 of each of the first and second food trays 18, 20 may have four rounded corner sections 60 adjacent the food tray flange 28. It is contemplated that the relatively larger lateral width at the first and second ends 50, 52 allows for coverage beneath the food tray flange 28 at such locations. As best viewed in FIGS. 12, 14, and 16, each of the first and second ends may have a concave filet 62 cooperatively sized and configured to receive a rounded corner section of a respective one of the first and second food trays. Such cooperative sizing is contemplated to facilitate a continuity of the seal between the food tray flange 28 of the first and second food trays 18, 20 and stopper rail 14.

Further, each of the first and second grooves 44, 46 may have opposing first and second stopper groove ends 64, 66. Referring additionally to FIG. 9, there is depicted an enlarged cross sectional view of a portion of the support pan 10 at the first stopper groove 44 as viewed along axes 9-9 of FIG. 2. The first and second stopper grooves 44, 46 may each have a depth that tapers from the lip top surface 42 at the first stopper groove end 64 towards to the second stopper groove end 66 and tapers from lip top surface 42 at the second stopper groove end 66 toward the first stopper groove end 64. Such tapering allows for a smooth transition from the lip top surface 42 and into the first and second stopper grooves 44, 46. This is contemplated to facilitate an ease of cleaning of the first and second stopper grooves 44, 46. The first and second stopper grooves 44, 46 having a rounded cross section is further contemplated to facilitate an ease of cleaning.

The pan sidewall 30 may have opposing longitudinal sides 68 and opposing lateral sides 70 disposed between the longitudinal sides 68. The first and second stopper grooves 44, 46 may be respectively disposed along the longitudinal sides 68. In this embodiment, the stopper rail 14 positioned in a horizontal manner across the support pan 10 and perpendicular to the lateral sides 70.

Referring additionally to FIG. 8 there is depicted an enlarged cross sectional view of a portion of the support pan 10 at the first stopper groove 44 as viewed along axes 8-8 of FIG. 2. The stopper rail 14 may be cooperatively sized and configured to have the stopper upper surface 54 and the lip top surface 42 vertically aligned with the first and second positioning tabs 56, 58 being respectively received in the first and second stopper grooves 44, 46 with the rail body 48 spanning across the open top 38 and with the first and second food trays 18, 20 positioned in the enclosed container. Each longitudinal side 68 may have a groove ledge 72 disposed along the upper edge 34. The first and second stopper grooves 44, 46 may each be disposed between a respective one of the groove ledges 72 and the lip top surface 42. Each groove ledge 72 of each longitudinal side 68 may be disposed at a distance from the closed bottom 36 less than a distance from the lip top surface 42 to the closed bottom 36. As such, the each ledge 72 is stepped down from the lip top surface 42. In order to provide a continuity of a supporting surface for each food tray flange 38 of the first and second food trays 18, 20, the amount of difference in vertical step down between each groove ledge 72 and the lip top surface 42 is thickness of the rail body 48 at such location.

The support pan 10 may include a peripheral bead 74 extending around a periphery of the support pan lip 40 and a depending flange 76 extending downward and outward from the bead 74. The peripheral bead 74 is raised in comparison to the lip top surface 42. The peripheral bead 74 may be used to contain any liquid that may be disposed upon the lip top surface 42. Further, a lid or cover (not shown) may be used with the support pan 10 to fully enclose the support pan 10. The lip top surface 42 may provide a continuous surface upon which such lid or cover may rest. Condensation that may form upon an underside of the lid or cover may run off upon the lip top surface 42, and the peripheral bead 74 contains such condensation from spilling over the support pan lip 40 outside of the support pan 10.

The pan sidewall 30 may have upper and lower sidewalls 78, 80 and a tray ledge 82 disposed between the upper and lower sidewalls 78, 80. As mentioned above the chafing dish assembly 10 may further include the suspension tray 16. The suspension tray 16 may have a rectangular tray top 84 with an outer periphery 86 with rounded corners. The outer periphery 86 is sized to fits inside the support pan 10 and rests on the tray ledge 82. The suspension tray 16 may have a pocket 88 depending from the tray top 84 toward the closed bottom 36 of the support pan 10 with the suspension tray 16 resting upon the tray ledge 82. The suspension tray 16 may have a pocket bottom 90 spaced apart from the closed bottom 36. In the embodiment depicted, the suspension tray 16 includes two such pockets 88. The pockets 88 are preferably rectangular in shape. In the depicted embodiment, the long sides of the rectangular shape of the tray top 84 extend parallel to the longitudinal side 68 of the support pan 10. The pockets 88 advantageously form waterproof containers with an open top, and water is placed into the pockets 88 during use.

The support pan 10 may include guide tabs 92 extending from the tray ledge 82 towards the open top 38, and the suspension tray 16 may be disposed between respective ones of the guide tabs 92. The guide tabs 92 are used to position the suspension tray 16 to be relatively centered in relation to the longitudinal and lateral sides 68, 70. It is contemplated that such guiding may be needed where one or more suspension tray(s) 16 are utilized of various sizes. The suspension tray 16 advantageously has the outer periphery 86 conforming in shape to the tray ledge 82 of the support pan 10 and sized to readily fit within the lateral bounds as defined by the guide tabs 92 so there is no binding between support suspension tray 16 and the guide tabs 92 in the event that the suspension tray 16 expands as the temperature increases during use.

The tray ledge 82 to vertically positioned to allow the tray top 84 to be spaced apart from the tray bottom 24 of each of the first and second food trays 18, 20. A distance between the tray ledge 82 and the top of the support pan lip 40 of about 3-5 inches and preferably about 4 inches, is believed suitable for standard food trays having a depth of about 2.7 inches (about 6-7 cm). The pocket bottom 90 of each pocket 88 extends downwardly toward the closed bottom 36 of the support pan 10, but is spaced apart from the closed bottom 36. The spacing allows for an air insulation gap to be formed to maintain the temperature of the suspension tray 16 during use.

The chafing dish assembly 12 may further incudes a water permeable packet of material (not shown) that reacts exothermically with water to produce steam suitable for use in heating food, and the packet of material may be placed in the pocket 88. During use, a packet containing an exothermic compound that is reactive with water and compatible with food and potential human consumption is placed each pocket 88. The exothermic compound is advantageously calcium oxide or another compound having an exothermic reaction with water sufficient to cause the water to form steam. Such food compatible, water-activated, exothermic compounds are known and are not described in detail herein. The compound is advantageously held in a thin walled, fabric bag, or a woven or perforated polymer bag such as polyethylene so water can pass through the bag and steam can leave the bag. Each packet may be generally rectangular and sized to fit horizontally within each pocket 88 with sufficient room to anticipate and expanded shape of the packet during use and saturation with water. Each pocket 88 is deep enough so that the expanded packet may rest on the pocket bottom 90 and not hit the tray bottom 24 of the first and second food trays 18, 20.

During use, a user places a predetermined amount of water in each pocket 88. The separate porous packet of exothermic material is then placed in each pocket 30 and into the water in each pocket. The order could be switched with water added second, but that is believed less desirable. As more water is absorbed by the packet 40, the exothermic reaction with the exothermic compound becomes more pronounced so that in about 30 seconds or so the water in the pocket 88 is boiling and forms steam. During the time the packets are added and before the steam forms, the user advantageously sets the stopper rail 14 upon the support pan 10 with the first and second positioning tabs 56, 58 respectively disposed in the first and second stopper grooves 44, 46. The food trays 18, 20 are then respectively placed on either side of the stopper rail 14 so as to effectively cover the entire open top 38 of the support pan 10.

As the steam is formed by the reactive exothermic compound in each pocket, the steam fills the space between the first and second food trays 18, 20 and the stopper rail 14 and the suspension tray 16 to heat the food in the first and second food trays 18, 20. The stopper rail 14 advantageously functions stop or at least mitigates the escape of steam between the first and second food trays 18, 20.

The support pan 10 may include four pan corners 94. Such pan corners 94 may be rounded to facilitate an ease of manufacturing, an ease of cleaning, and an ease of separation when more than one support pan 10 is stacked and nested within each other. A corner radius of about 0.5 inches may be suitable.

A reinforcement element 96 may be disposed at each of the pan corners 94 that extend upward from the closed bottom 36. Each reinforcement element 96 may be used to add structural strength as such location when more than one support pan 10 is stacked or nested within another. The reinforcement elements 96 are used to provide vertical separation between the nested support pans 10 to allow the support pans 10 to be readily un-nested and separated.

The support pan 10 may include leg sections 98. In this embodiment, the support pan 10 includes six leg sections 98. A leg section 98 is formed in the lower sidewall 80 at each of the four pan corners 94 and one at a mid-location along each of the two longitudinal sides 68. The leg sections 98 are contemplated to provide stability for the support pan 10 and the overall chafing dish assembly 12 when placed upon a resting surface. This allows for stability without the need for any additional support frame to be used.

The various components of the chafing dish assembly 12 may be formed of various materials which are well known to one of ordinary skill in the art. In this regard, the support pan 10, the stopper rail 14 and the suspension tray 16 may be made of metal or plastic. In an embodiment, the support pan 10, the stopper rail 14 and/or the suspension tray 16 are made of thin-walled aluminum or plastic designed for disposable, single use applications. The wall thickness of these disposable pans and trays are so thin the walls bend easily, crack easily if made of plastic, and punctures easily. Making the support pan 10, the stopper rail 14 and/or the suspension tray 16 out of disposable, thin-walled, formed aluminum or plastic allows an inexpensive chafing dish which may be disposed of to avoid or reduce clean-up.

In other embodiments, the support pan 10, the stopper rail 14 and the suspension tray 16 may be made of plastic rather than a metal, such as a thin aluminum. The plastic components may be formed using thermoforming or injection molding or drawing techniques. As the support pan 10, the stopper rail 14 and the suspension tray 16 do not themselves contain food and come directly in contact with food, the food-compatibility requirements are not significant. In the embodiment depicted, the stopper rail 14 is formed of a molded plastic and includes various truss-like structural members as is viewed in the bottom views of FIGS. 14 and 16. This allows the component to be formed to be structurally strong while relatively light weight. Suitable plastics compatible with food heating and selected to maintain their strength under the steam generating environment are believed to include polypropylenes, polyethylenes, polyurethanes, polycarbonates, PMMA, UHMW and acrylic materials. Polystyrene and expanded polystyrene are also believed suitable. A recyclable polymer is preferred. Wall thicknesses of about 0.04 to 0.06 inches are believed suitable for single use, disposable applications. Wall thickness of about 0.1 to 0.13 inches (and thicker) are believed suitable for reusable application.

It is contemplated that the chafing dish assembly 12 may include more than on stopper rail 14. For example, the chafing dish assembly 12 may be used with three food trays, which may be sized as ⅓ pan sized food trays. In such as case, two stopper rails which are similar to the stopper rail 14 could be used. The three food trays would be used in a side by side configuration with one of the food trays disposed between the other two. As stopper rail would be positioned on each side of the central food tray and would act to stop or mitigate the escape of steam thereat. It is contemplated that the first and second grooves 42, 44 would be commonly used by both such stopper rails. In this regard the first and second grooves 42, 44 may be formed to have a sufficient length respectively spanning along the longitudinal sides 68 so as to receive the stopper rail(s) 14 at various positions along the longitudinal sides as would accommodate the various number of food trays.

The upper and lower sidewalls 78, 80 of the support pan 10 may be inclined outward in a direction from the closed bottom 36 toward the open top 38 to allow a generous draft angle, such as 5 to 10 degrees. Such angle is contemplated to allow for nested support pans 10 to be readily un-nested and separated.

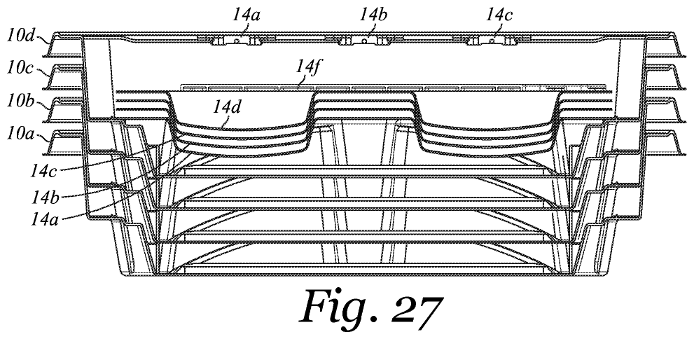

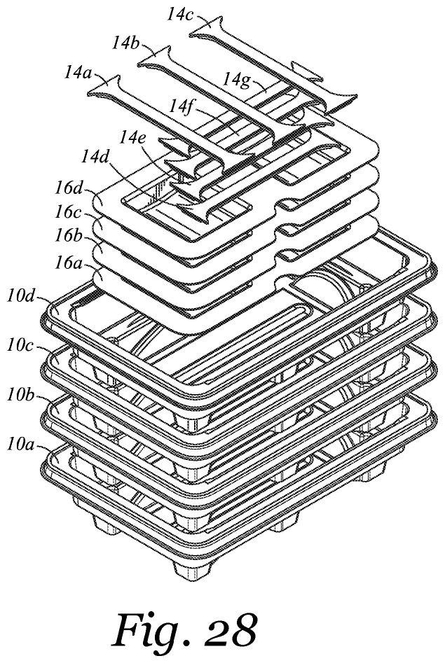

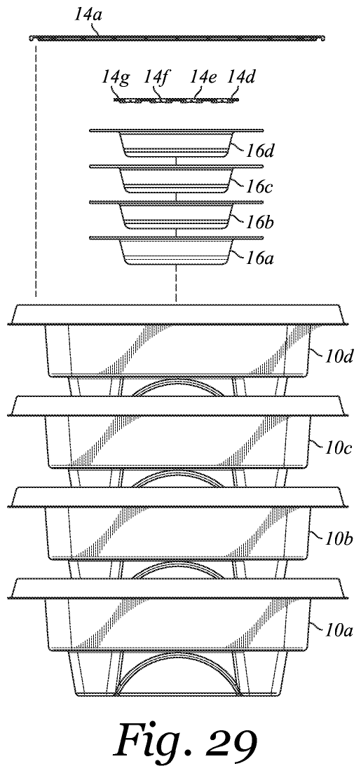

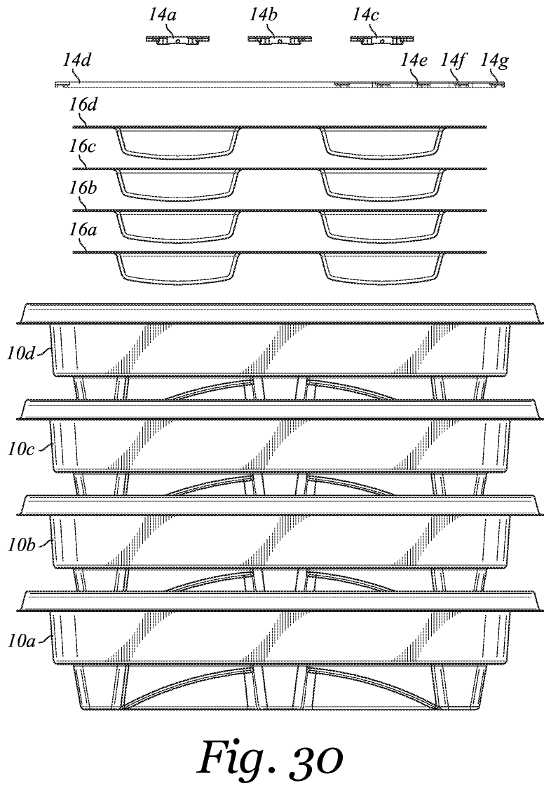

Referring to FIGS. 24-30, there are provided support pans 10a-d (which are configured similar to the support pan 10), suspension trays 16a-d (which are configured similar to the suspension tray 16), and stopper rails 14a-g (which are configured similar to the stopper rail 14). In this regard, it is contemplated that the construction of the support pans 10a-d, the suspension trays 16 a-d, and stopper rails 14a-g may be stacked and nested for relatively compact shipment and/or storage. In this embodiment, the support pans 10a-d are stacked and nested with the support pan 10d being the topmost one. The suspension trays 16a-d are stacked and nested with the suspension tray 16a being supported by the support pan 10d. The stopper rails 14a-c are engaged with the first and second stopper grooves 44, 46 of the support pan 10d. The stopper rails 14d-g are simply placed atop the suspension tray 16d. It is understood that a variable number of such components may be alternatively utilized. It is contemplated that a variable number of packets of exothermic material (not shown) may also be placed inside the support pan 10d upon the suspension tray 16d. The overall combination of these various stacked and nested components may be form a desirable shipping assembly, especially when wrapped in thin, transparent plastic shipping material, such as cellophane or shrink-wrap.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Given the above disclosure, one skilled in the art could devise variations that are within the scope and spirit of the invention, including various ways of configuring the stopper rail 14 and the support pan 10. Further, the various features of this invention can be used alone, or in varying combinations with each other and are not intended to be limited to the specific combination described herein. The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A chafing dish assembly for use with first and second food trays, each of the first and second food trays having a rectangular tray top, a tray bottom, a food tray sidewall extending between the tray top and tray bottom, and a food tray flange extending outward from the tray top, the chafing dish assembly comprising:
a rectangular support pan having:
a pan sidewall having a bottom edge and an upper edge;
a closed bottom joining the bottom edge to form an enclosed container;
an open top surrounded by the upper edge and disposed opposite the closed bottom; and
a support pan lip extending outwardly from the upper edge, the support pan lip having a lip top surface sized and configured to support the food tray flanges of the first and second food trays, the support pan lip having first and second stopper grooves disposed along the lip top surface; and
a stopper rail having:
an elongate rail body having first and second ends;
a stopper upper surface extending along the rail body between the first and second ends; and
first and second positioning tabs respectively extending from each of the first and second ends, the stopper rail being cooperatively sized and configured with the first and second positioning tabs respectively received in the first and second stopper grooves with the rail body spanning across the open top and with the first and second food trays positioned in the enclosed container and the food tray flange of the first food tray being supporting by the stopper upper surface and the lip top surface and the food tray flange of the second food tray being supporting by the stopper upper surface and the lip top surface.

2. The chafing dish assembly of claim 1 wherein the first and second ends of the rail body each extending in a direction away from the stopper upper surface.

3. The chafing dish assembly of claim 1 wherein the first and second ends of the rail body are curved and the first and second positioning tabs respectively extend distally from the first and second ends.

4. The chafing dish assembly of claim 1 wherein the rail body has a lateral width less than a lateral width of the first and second positioning tabs.

5. The chafing dish assembly of claim 1 wherein the rail body has a lateral width that increasingly tapers at the first and second ends.

6. The chafing dish assembly of claim 1 wherein the food tray sidewall of each of the first and second food trays has four rounded corner sections adjacent the food tray flange, each of the first and second ends has a concave filet cooperatively sized and configured to receive a rounded corner section of a respective one of the first and second food trays.

7. The chafing dish assembly of claim 1 wherein the stopper rail is cooperatively sized and configured to have the stopper upper surface and the lip top surface vertically aligned with the first and second positioning tabs being respectively received in the first and second stopper grooves with the rail body spanning across the open top and with the first and second food trays positioned in the enclosed container.

8. The chafing dish assembly of claim 1 wherein each of the first and second stopper grooves have a rounded cross section.

9. The chafing dish assembly of claim 1 wherein each of the first and second stopper grooves have opposing first and second groove ends, the first and second stopper grooves each have a depth that tapers from the lip top surface at the first stopper groove end towards to the second stopper groove end and tapers from the lip top surface at the second stopper groove end toward the first stopper groove end.

10. The chafing dish assembly of claim 1 wherein the pan sidewall has opposing longitudinal sides and opposing lateral sides disposed between the longitudinal sides, the first and second stopper grooves are respectively disposed along the longitudinal sides.

11. The chafing dish assembly of claim 10 wherein each longitudinal side has a groove ledge disposed along the upper edge, the first and second stopper grooves are each disposed between a respective one of the groove ledges and the lip top surface.

12. The chafing dish assembly of claim 11 wherein each ledge of each longitudinal side is disposed at a distance from the closed bottom less than a distance from the lip top surface to the closed bottom.

13. The chafing dish assembly of claim 1 wherein the support pan includes a peripheral bead extending around a periphery of the support pan lip and a depending flange extending downward and outward from the bead.

14. The chafing dish assembly of claim 1 wherein the pan sidewall has upper and lower sidewalls and a tray ledge disposed between the upper and lower sidewalls.

15. The chafing dish assembly of claim 14 further includes a suspension tray, the suspension tray has a rectangular tray top with an outer periphery that fits inside the support pan and rests on the tray ledge, the suspension tray has a pocket depending from the tray top toward the closed bottom of the support pan.

16. The chafing dish assembly of claim 15 wherein the suspension tray has a pocket bottom spaced apart from the closed bottom.

17. The chafing dish assembly of claim 15 wherein the support pan includes guide tabs extending from the tray ledge towards the open top, the suspension tray is disposed between respective ones of the guide tabs.

18. The chafing dish assembly of claim 1 wherein the support pan and stopper rail are made of metal.

19. The chafing dish assembly of claim 1 wherein the stopper rail is a first stopper rail, and the chafing dish assembly further includes a second stopper rail sized and configured the same as the first stopper rail, the first and second stopper rails are positionable with the respective first and second positioning tabs being respectively received in the first and second stopper grooves with the rail bodies spanning across the open top.
